(19) United States
(12) Patent Application Publication
(10) Pub. No.: US 2009/0313334 A1
(43) Pub. Date: Dec. 17, 2009

(54) INSTANT MESSENGER CONVERSATION TOPIC TABS

(75) Inventors: Lisa A. Seacat, San Francisco, CA (US); Meena Nigam, Belmont, CA (US)

Correspondence Address: LEVEQUE INTELLECTUAL PROPERTY LAW, P.C., 241 E. 4th Street, #102, FREDERICK, MD, 21701, US

(73) Assignee: International Business Machines Corporation, Armonk, NY (US)

(21) Appl. No.: 12/137,957

(22) Filed: Jun. 12, 2008

(51) Int. Cl. G06F 15/16

(52) U.S. Cl. 709/206

(57) ABSTRACT

A method and system provides for separating conversation topics within a user's chat by tabs. Authorized users may organize and control access to IM conversations organized by topics. An existing instant messaging user with access to an instant messaging conversation may tag one or more portions of the instant messaging conversation as their tagged conversation topics. Existing instant messaging users may control access to the tagged conversation topics by inviting one or more new instant messaging users to selectively participate in the tagged conversation topics and not the instant messaging conversation in its entirety.

### BACKGROUND

It is often difficult for instant message (IM) users to manage conversations even when only speaking with a small number of individuals. The conversation can easily switch between topics ranging from anything from work related topics to their children's sports activities. Some IM clients, such as Sametime Connect, allow IM users to place all of their chat conversations in the same window separating them with a tab. There is, however, no known solution that allows users to organize conversations per user based on varied topics.

### BRIEF SUMMARY

In accordance with embodiments consistent with the present invention, a method and system provides for organizing and controlling access to instant messaging conversations organized by topics. An existing instant messaging user, of a plurality of existing instant messaging users with access to an instant messaging conversation, tags one or more portions of the instant messaging conversation as tagged conversation topics of the existing instant messaging user. One or more of the plurality of existing instant messaging users may control access to the tagged conversation topics by inviting one or more new instant messaging users to selectively participate in the tagged conversation topics and not the instant messaging conversation in its entirety. In which of the one or more tagged conversation topics one or more new instant messaging users may participate is selected by one or more of the existing instant messaging users. The one or more new instant messaging users may then be invited to participate in the selected one or more tagged conversation topics and not the instant messaging conversation in its entirety.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a flowchart that illustrates an exemplary flow, in accordance with various embodiments disclosed herein.

FIG. 2 illustrates an exemplary IM conversation between two IM users.

FIG. 3 illustrates a dialog box user interface for inviting one or more new IM users to certain tabbed portions of an IM conversation.

### DETAILED DESCRIPTION

In accordance with embodiments consistent with the present invention, a method and system provides for organizing and controlling access to instant messaging conversations organized by topics. Conversations are separated out based on topics into new tabbed areas, thereby helping to organize individual IM users. An existing instant messaging user, of a plurality of existing instant messaging users with access to an instant messaging conversation, tags one or more portions of the instant messaging conversation as tagged conversation topics of the existing instant messaging user. One or more of the plurality of existing instant messaging users may control access to the tagged conversation topics by inviting one or more new instant messaging users to selectively participate in the tagged conversation topics and not the instant messaging conversation in its entirety. In which of the one or more tagged conversation topics one or more new instant messaging users may participate is selected by one or more of the existing instant messaging users. The one or more new instant messaging users may then be invited to participate in the selected one or more tagged conversation topics and not the instant messaging conversation in its entirety.

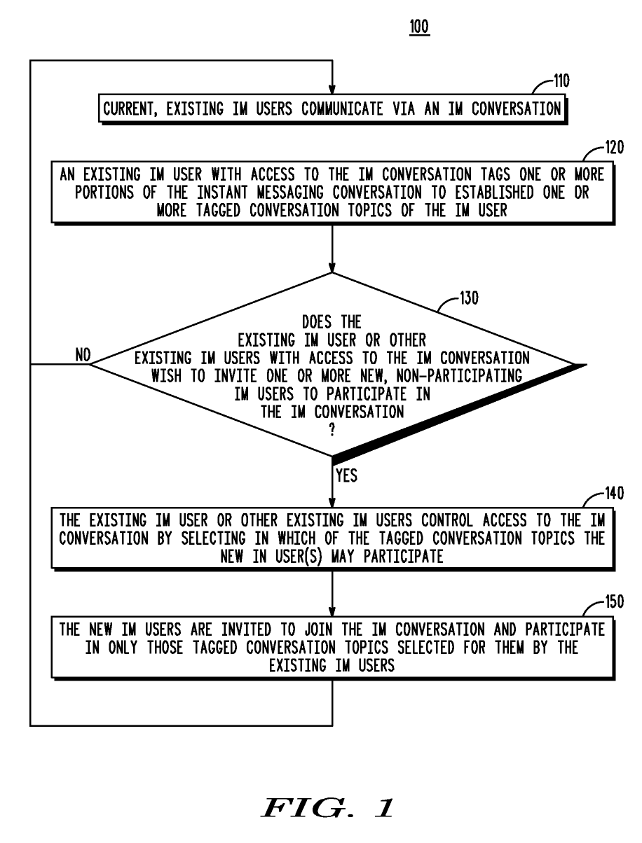

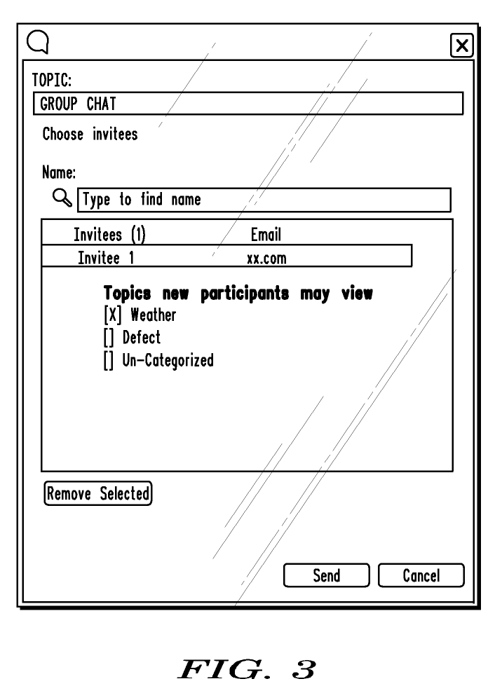

Reference is now made to flow 100 of FIG. 1. At Block 110, IM users interact with the IM clients as they ordinarily would, by participating in one or more IM conversations. The user may be chatting with a buddy from their chat list, for example. At Block 120, as the IM conversation takes place, an existing IM user or participant having access to the IM conversation can tag one or more portions of the IM conversation to establish one or more tagged conversation topics associated with the existing IM user. This may occur as the IM conversation is taking place, with the IM existing user making off parts of the conversation as pertaining to one or more specific topics. This may be done manually or automatically, as will be described. The current user or users may wish to invite others to the conversation. Thus, at Decision Block 130, if the existing IM user or other current users wish to invite one or more new, currently non-participating IM users to participate, then the flow continues to Block 140. The existing IM user(s) control access to the IM conversation by selecting in which of the tagged conversation topics the new IM user(s) may participate. This may occur through user interaction with a user interface, such as the dialog box illustrating in FIG. 3, for example, in which current participants may choose which topics a new user can view and/or participate in. At Block 150, the one or more new IM users are invited to join the IM conversation but participate only in those tagged conversation topics selected for them by the existing IM user(s). In other words, a new user may join and only see that information on topics that are relevant to them and allowed by other IM participants.

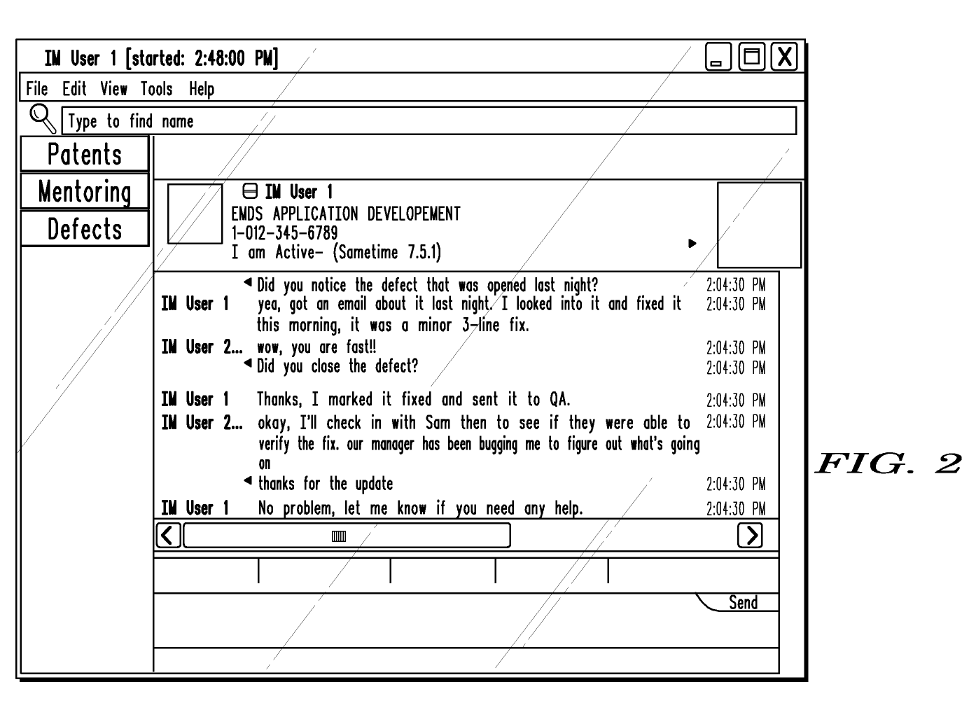

Creation of new conversation tabs may occur during a conversation, and may be performed automatically or manually. As the user is chatting with a fellow IM user, the topic changes to a new subject or topic. The system may either recognize this new switch or the user may manually indicate that a new topic is being discussed. The chat conversation is moved to a new tab for the same user with the related information. If the user wishes to move content between topics, they could do so by highlighting the text and adding to existing tabs or creating a new tab. When the user closes the chat window, the will have the option save all the chats by topics, such as USER1.PATENTS.txt, USER1.MENTORING.txt, USER1.DEFECTS.txt. Topic tab examples illustrated in FIGS. 2 and 3 include PATENTS, MENTORING, DEFECTS, WEATHER, UN-CATEGORIZED, for USER1, by way of illustration and not limitation. Additionally, users can set preferences on how to handle their new topic windows. For example, they may wish to only see those topics discussed within the past 10 minutes, in which case, the inactive tabs would close automatically and not be shown for viewing.

When a new conversation tab is saved, the system could pull up a list of same-named tabs within the system. Then, the user can select from that list or create a new file to save the information. This would provide a way to have a running history of a topics conversation. It could be based on USER1.DEFECTS or through an entire set of buddies, such as ALL.DEFECTS.

With regard to manual topic tab creation, the user may type a keyword to indicate that the next information should be contained within a tab. The user could highlight and right click to select a tab to move the content to. The content could then be highlighted and drag and dropped to the desired tab. Automatic topic tab creation may encourage using a method to extract a topic or to recognize a change in idea flows from an IM conversation; the general overall topic could then be used to create a new tab.

Consider the IM conversation illustrated in FIG. 2. There are three different tabs that have been created for USER1: PATENTS, MENTORING, DEFECTS. It can be seen that the DEFECTS tab is highlighted. Accordingly, only the portion of the IN conversation having to do with DEFECTS is displayed:
USER 2: did you notice the defect that was opened last night?
USER 1: yea, got an email about it last night. I looked into it and this morning, it was a minor 3-line fix.
USER 2: wow, you are fast!!
   Did you close the defect?
USER 1: Thanks, I marked it fixed and sent it to QA.
USER 2: okay, I'll check in with Sam then to see if they were able to verify the fix. our manager has been bugging me to fix . . . .
   Thanks for the update
USER 1: No problem, let me know if you need any help.
   However, the conversation may have also included information directed to weather, as illustrated by the following IM exchange:
USER 2: Hey, can you believe this rain
USER 1: no! It's out of control and has been raining for 3 hours straight
USER 2: Yeah, the trees outside my window have uprooted
USER 1: Did you fix that bug for PIM
USER 2: I heard on the news that all the city transportation lines were closed
USER 2: Yes, it's fixed and checked in
USER 1: Cool
   But, because the DEFECT tab is selected, only those portions of the conversation directed to DEFECTS are viewable.

FIG. 3 illustrates a dialog window, such as might be used to invite others to selectively join certain topics of the IM conversation. In this figure, it can be seen that INVITEE1 is granted permission to only view the WEATHER topics tab; this user is not given permission to view the DEFECT topic, just described above. Those conversation pieces that are marked as the topic “DEFECT” and those conversations that weren't marked at all would not be visible when the new user joined in on the conversation. Instead, only the WEATHER information would be viewable to INVITEE1.

Such a conversation viewable to INVITEE1 may include the following:
USER 2: Hey, can you believe this rain
USER 1: no! It's out of control and has been raining for 3 hours straight
USER 2: Yeah, the trees outside my window have uprooted
USER 2: I heard on the news that all the city transportation lines were closed

The ability to select sections of an IM conversation that are to be marked off and for the user to assign a conversation topic to each section as a topic, so that multiple topic tabs may be displayed for selected by a user in the same window.

It is further envisioned that in accordance with certain embodiments, an IM user can manually drag and drop the sections of the conversation that are of a certain topic and place them in the correct topic tab in order to recall that information later. They might choose not to “save” information because it's not important. Suppose USER1 did not care about the weather but was interested in logging information about bug fixes. In this case she might save the bug information. However, USER2 might be interested in saving everything so USER2 opts to save both the WEATHER and the DEFECT conversations. We could also specify a tag or keyword to specify to the system which tab the topics belong to, such as follows:

USER 2: WEATHER: Hey, can you believe this rain
USER 1: WEATHER: no! It's out of control and has been raining for 3 hours straight
USER 2: WEATHER: Yeah, the trees outside my window have uprooted
USER 1: DEFECT: Did you fix that bug for PIM
USER 2: WEATHER: I heard on the news that all the city transportation lines were closed
USER 2: DEFECT: Yes, it's fixed and checked in

### USER 1: DEFECT: Cool

The way these tags are added could be automatically based on the last line until the user changes it. Or, the system might choose from a list of past tags. Or, the system might prompt the user to begin typing the tag and then they can select. Alternately, the system could show a list from which the user may choose, etc. Any of these implementation details allows USER 1 and USER 2 to continue talking about various topics without leaving the current chat window; this may be contrasted with other programs which make the user go to the tab first and then chat. Also, all conversations on a topic may be saved for easy recall, or the user could choose to only view topic conversations for a specific IM buddy. Inviting others and allowing them to see only the discussion on a specific topic rather than the entire conversation is a unique feature consistent with certain embodiments of the present invention; this is in contrast to other IM programs, such as Microsoft, that require both users to use their client. The embodiments disclosed herein work with users from other instant messaging clients. While other users might not have the support of topics the users that do would have the ability to store their conversations in an easy to retrieve manner.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for organizing and controlling access to instant messaging conversations organized by topics, comprising:
an existing instant messaging user, of a plurality of existing instant messaging users with access to an instant messaging conversation, tagging one or more portions of the instant messaging conversation as one or more tagged conversation topics of the existing instant messaging user;
one or more of the plurality of existing instant messaging users controlling access to the one or more tagged conversation topics available to one or more new instant messaging users by selecting in which of the one or more tagged conversation topics of the instant messaging conversation the one or more new instant messaging users can participate;
inviting the one or more new instant messaging users to participate in the selected one or more tagged conversation topics and not the entire instant messaging conversation; and
displaying the selected one or more tagged conversation topics of the instant messaging conversation to the one or more new instant messaging users in a single window and not displaying non-selected topics of the one or more tagged conversation topics of the instant messaging conversation to the one or more new instant messaging users in the single window.
